(19) United States
(12) Patent Application Publication
(10) Pub. No.: US 2010/0033830 A1
(43) Pub. Date: Feb. 11, 2010

(54) WEARABLE IMAGE DISPLAY DEVICE

(76) Inventor: Man Fat Yung, Kowloon (HK)

Correspondence Address: LEYDIG VOIT & MAYER, LTD, 700 THIRTEENTH ST. NW, SUITE 300, WASHINGTON, DC, 20005-3960, US

(21) Appl. No.: 12/189,346

(22) Filed: Aug. 11, 2008

(51) Int. Cl. G02B 27/01

(52) U.S. Cl. 359/630

(57) ABSTRACT

A wearable image display device for superimposing a virtual image into the wearer's field of vision includes a lens, for spectacles or the like, which includes inner and outer lens portions bonded together at complementary boundary surfaces of the lens portions. One of two opposing optical surfaces of the lens is located on each lens portion. Each boundary surface is disposed between the optical surfaces of the inner and outer lens portions to avoid discontinuities on the optical surfaces. A partially transmissive reflector is located on one of the boundary surfaces and a microdisplay radiates light internally through the lens between the optical surfaces of the inner and outer lens portions to strike the partially transmissive reflector and reflect the light out of the lens to a user's eye.

### TECHNICAL FIELD

The present invention relates to a small image display device that can be used while worn on the head.

### BACKGROUND OF THE INVENTION

Recently, small image display devices have been proposed that allow users to view both images and the surrounding environment by providing virtual images superimposed upon part of the field of vision.

An image display device of this type is disclosed in, for example, U.S. Pat. No. 6,384,982. Eyeglasses include a composite lens positioned in the wearer's field of vision, the composite lens having a partially reflective internal interface. A miniature display, such as a backlit liquid crystal display (LCD) is mounted to a frame for holding the composite lens. The LCD projects light through an edge of the composite lens against an interface between two portions of the composite lens and the light is then reflected into the user's eyes to produce the image.

The image display device of this type provides the capacity to see the projected images by the movement of the eyes without obscuring a large part of the user's visual field. It can be readily integrated into eyewear and avoids the need for external appendages such as mirrors or fibre optics. However, this image display device has some drawbacks.

In this prior art device, as shown in FIGS. 1 and 2, the internal interface is made by forming planar faces 60, 61 on two portions 62, 63 from which the composite lens is formed, one of which includes a partially silvered portion 64. The composite lens is assembled from the two portions with the faces 60, 61 generally abutting. However, this construction produces two visible lines or discontinuities 65, 66 where the faces 60, 61 intersect with the inner and outer optical surfaces 67, 68 of the lens. It is an object of the present invention to overcome or substantially ameliorate the above disadvantages or more generally to provide an improved wearable image display device.

### DISCLOSURE OF THE INVENTION

According to one aspect of the present invention there is provided a wearable image display device comprising:

a mounting for mounting upon a wearer's head;

at least one composite lens carried by the mounting, the composite lens having inner and outer lens portions, each lens portion including a respective one of two opposing optical surfaces for positioning in a wearer's line of sight;

a microdisplay for radiating light to form an image of a source object;

an optical pathway disposed internally within the composite lens to receive the light from the microdisplay, the optical pathway having at least a portion disposed along and between the optical surfaces of the inner and outer lens portions; and

a partially transmissive reflector disposed internally within the composite lens to reflect the light, which has passed along the optical pathway, out of the composite lens to a user's eye, wherein each lens portion includes a boundary surface, the boundary surfaces are complementary, each boundary surface is disposed between the optical surfaces of the inner and outer lens portions, and the partially transmissive reflector is formed on at least one of the boundary surfaces.

Preferably each lens portion has a peripheral edge extending between its boundary surface and optical surface, the boundary surfaces include first, second and third intersecting sections, wherein the partially transmissive reflector is a coating provided on the first section, the first section separates the second section from the third section and the second and third sections are substantially planar. Preferably the second and third sections are substantially parallel.

Preferably the intersections between the first section and the second and third sections of the boundary surfaces are radiused.

Preferably the first section is planar and the device further includes a magnifying optic disposed along the optical pathway. Alternatively, the first section may be curved to provide magnification.

Preferably the device includes a thin adhesive film bonding the boundary surfaces together, the lens portions being formed of like material and the adhesive film having a refractive index substantially equal to a refractive index of the material forming the lens portions.

Preferably the inner lens portion is disposed proximate the wearer's eye in use, the partially transmissive reflector is formed as a coating applied to the first section of the inner lens portion, the lens has first and second opposing edges, the microdisplay is mounted to the first edge, and the second and third sections are inclined such that the first edge is relatively thicker than the second edge.

In another aspect the invention provides eyewear comprising:

a frame for mounting upon a wearer's head;

at least one composite lens carried by the frame, the composite lens having inner and outer lens portions bonded together at complementary surfaces of each of the lens portions by a thin adhesive film, the adhesive film having a refractive index substantially equal to a refractive index of the material forming the lens portions, each lens portion including a respective one of two opposing optical surfaces for positioning in a wearer's line of sight;

a microdisplay for radiating light to form an image of a source object;

an optical pathway disposed internally within the inner lens portion to receive the light from the microdisplay, the optical pathway having at least a portion disposed along and between the optical surfaces of the inner and outer lens portions; and

a partially transmissive reflector disposed internally within the composite lens to reflect the light, which has passed along the optical pathway, out of the composite lens to a user's eye, wherein each of the complementary surfaces is disposed between the optical surfaces of the inner and outer lens portions, and the partially transmissive reflector is formed on at least one of the boundary surfaces.

This invention provides a device which is effective and efficient in operational use, which may be economically constructed and which avoids discontinuities in the optical surfaces of the device.

### BRIEF DESCRIPTION OF THE DRAWINGS

Preferred forms of the present invention will now be described by way of example with reference to the accompanying drawings, wherein:

FIG. 1 is an exploded side view of a prior art lens system for a wearable display device;

FIG. 2 is a front view of the lens system of FIG. 1;

FIG. 3 is a schematic pictorial view of a wearable image display device of the present invention, and

FIG. 4 is an exploded side view of the optical components of the wearable image display device of FIG. 3.

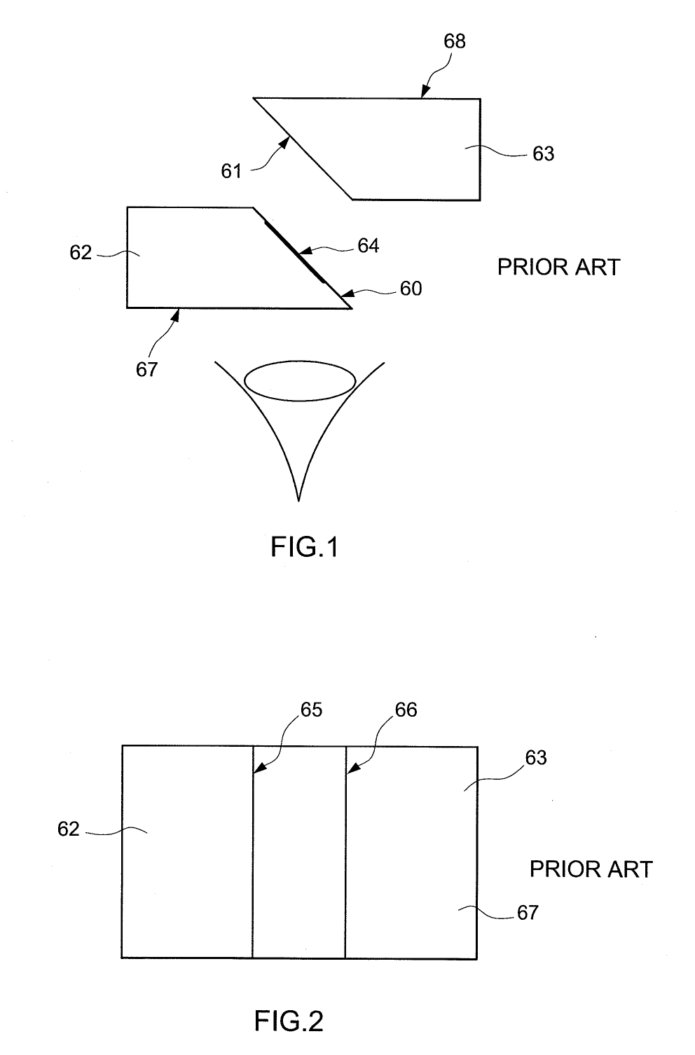

### DESCRIPTION OF THE PREFERRED EMBODIMENTS

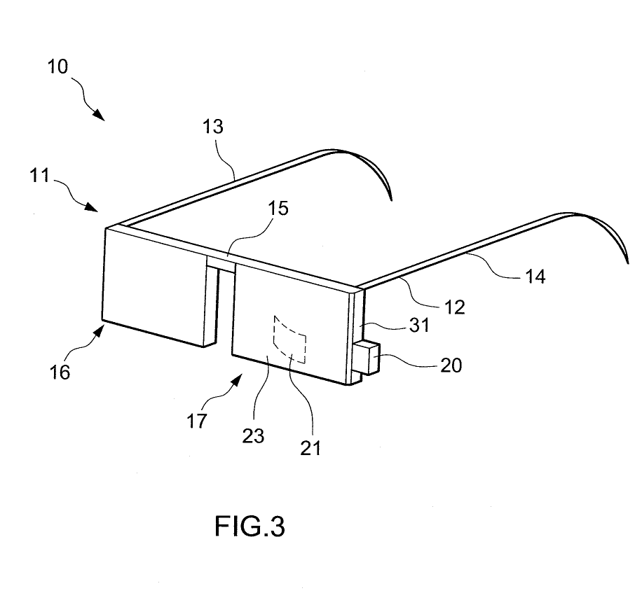

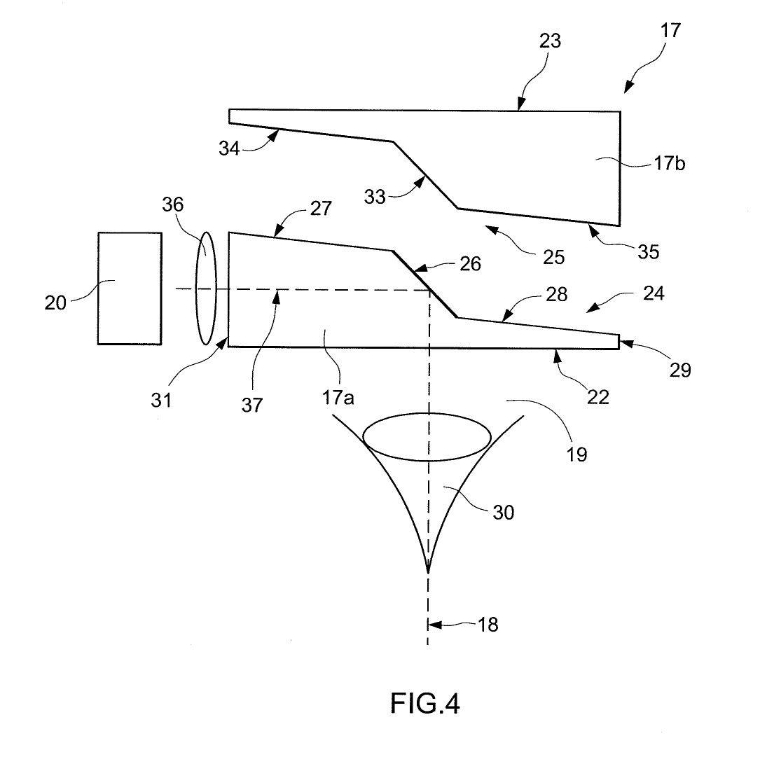

Referring to FIGS. 3 and 4, a wearable image display device 10 according to a preferred embodiment of the invention is provided as comprising a pair of spectacles 11 including a frame 12 having a pair of laterally spaced temples 13, 14, a bridge 15 and a pair of lenses 16, 17. The lenses 16, 17 may be either of suitable prescription or of non-corrective construction. Frame 12 including temples 13, 14 and bridge 15 are constructed and sized for mounting on the head of an individual wearer as is conventional, with the lenses being spaced from the wearer's eyes along a central axis 18 and defining an open eye cavity 19 therebetween. A battery powered microdisplay 20 is mounted to the lens 17 for continuously or selectively optically radiating its image into cavity 19. A partially transmissive reflector 21 within the lens 17 intercepts light radiated by the microdisplay 20 and to reflect light out of the lens 17 onto the wearer's eye 30.

The microdisplay 20 can be any electronically operated display, including reflective, emissive and scattering lights displays, as well as light transmissive displays. For example, the microdisplay 20 may include a liquid crystal display, a spatial light modulator, a grating, a mirror light valve or an LED array.

Conventional spectacles require a spherical concave inner surface to compensate for movement of the wearer's eye 30, however for the purposes of illustrating the invention the inner and outer opposing optical surfaces are shown here as planar. Positioned in the wearer's line of sight, the opposing inner and outer optical surfaces 22, 23 of the lens are formed on respective inner and outer lens portions 17a, 17b which are bonded together, to thereby form the lens 17.

In FIG. 4 the lens portions 17a, 17b making up the composite lens 17 are shown separated for clarity. The lens portions 17a, 17b may be formed of ground and polished glass and include respective boundary surfaces 24, 25 having a complementary shape. Each boundary surface 24, 25 is disposed between the optical surfaces 22, 23 such that ambient light passing through the lens 17 to the wearer's eye 30 also traverses both boundary surfaces 24, 25. Boundary surfaces 24, 25 are preferably bonded together by thin adhesive layer of Canada balsam or another adhesive having substantially the same refractive index as the glass of the lens portions 17a, 17b so as to avoid optical losses due to reflection (because of index mismatch) and scattering. Alternatively a direct interface may be provided in which the boundary surfaces 24, 25 are in direct optical and mechanical contact, or alternatively the boundary surfaces 24, 25 may be joined by diffusion bonding.

The partially transmissive reflector 21 has a generally rectangular boundary and is formed by partially silvering, or by the application of a dielectric coating or the like, to a part of a first planar section 26 of the boundary surface 24.

The first section 26 of the boundary surface 24 separates a second planar section 27 from a third planar section 28. The second and third sections are parallel, the second section 27 extending between the lateral edge 31 and the first section 26, the third section 28 extending between the opposite lateral edge 29 and the first section 26. The intersections between the first section 26 and the second section 27 and between the first section 26 and the third section 28 are radiused. Correspondingly, the boundary surface 25 of the lens portion 17b has complementary first, second and third sections 33, 34, 35 with radiused intersections therebetween. The second and third sections 27, 28 are inclined such that the lateral edge 31 to which the microdisplay 20 is mounted is relatively thicker than the opposite edge 29.

Mounted between the microdisplay 20 and the edge 31 is a magnifying optic 36 through which light from the microdisplay 20 is projected along an optical pathway represented by the dashed line 37 and disposed internally within the lens portion 17a between the optical surfaces 22, 23 of the inner and outer lens portions 17a, 17b for producing a magnified virtual image of the source object in the wearer's field of vision.

It will be appreciated that the principles of the display apparatus hereinabove disclosed find numerous applications in addition to the various embodiments illustrated in the drawings. For example, the wearable image display device 10 of the invention may be employed as a personal micro-display incorporating LEDs, LCDs for a sensory enhancement display such as for speech cueing, a monitor of time, a remote monitor of equipment or vehicles, or display for entertainment. By forming the boundary surfaces such that they are non-intersecting with the optical surfaces, discontinuities in the optical surfaces are eliminated.

Aspects of the present invention have been described by way of example only and it should be appreciated that modifications and additions may be made thereto without departing from the scope thereof.

1. A wearable image display device comprising:
a mounting for mounting upon a wearer's head;
at least one composite lens carried by the mounting, the composite lens having inner and outer lens portions, each of the inner and outer lens portions including two opposing optical surfaces, one of the two opposing optical surfaces being positionable in a wearer's line of sight;
a microdisplay for radiating light to form an image of a source object;
an optical pathway disposed internally within the composite lens to receive the light from the microdisplay, the optical pathway having at least a portion disposed along and between the optical surfaces of the inner and outer lens portions; and
a partially transmissive reflector disposed internally within the composite lens to reflect the light which has passed along the optical pathway, out of the composite lens to a user's eye, wherein each of the inner and outer lens portions includes a boundary surface, the boundary surfaces are complementary, each boundary surface is disposed between the two opposing optical surfaces of the inner and outer lens portions, and the partially transmissive reflector is located on at least one of the boundary surfaces.

2. The wearable image display device of claim 1, wherein
each of the inner and outer lens portions has a peripheral edge extending between the boundary surface and the optical surface,
the boundary surfaces include first, seconds and third intersecting sections,
the partially transmissive reflector is a coating located on the first section,
the first section separates the second section from the third section, and
the second and third sections are substantially planar.

3. The wearable image display device of claim 2, wherein the second and third sections are substantially parallel to each other.

4. The wearable image display device of claim 3, wherein intersections between the first section and the second and third sections of the boundary surfaces are radiused.

5. The wearable image display device of claim 4, wherein the first section is planar and the device further includes a magnifying optic disposed along the optical pathway.

6. The wearable image display device of claim 5, wherein
the inner lens portion is disposed proximate the wearer's eye in use,
the partially transmissive reflector is a coating applied to the first section of the inner lens portion,
the composite lens has first and second opposing edges,
the microdisplay is mounted to the first edge, and
the second and third sections are inclined such that the first edge is thicker than the second edge.

7. The wearable image display device of claim 1, wherein the device includes an adhesive film bonding the boundary surfaces together, the lens portions being formed of like material and the adhesive film having a refractive index substantially equal to refractive index of the material forming the lens portions.

8. Eyewear comprising:
a frame for mounting upon a wearer's head;
at least one composite lens carried by the frame, the composite lens having inner and outer lens portions bonded together at complementary surfaces of each of the inner and outer lens portions by an adhesive film, the adhesive film having refractive index substantially equal to a refractive index of the material forming the inner and outer lens portions, each of the inner and outer lens portions including two opposing optical surfaces, one of the two opposing optical surfaces being positionable in a wearer's line of sight;
a microdisplay for radiating light to form an image of a source object;
an optical pathway disposed internally within the inner lens portion to receive the light from the microdisplay, the optical pathway having at least a portion disposed along and between the optical surfaces of the inner and outer lens portions; and
a partially transmissive reflector disposed internally within the composite lens to reflect the light; which has passed along the optical pathway, out of the composite lens to a user's eye, wherein each of the complementary surfaces is disposed between the optical surfaces of the inner and outer lens portions, and the partially transmissive reflector is located on at least one of the boundary surfaces.

9. The eyewear of claim 8, wherein
each of the inner and outer lens portions has a peripheral edge extending between the boundary surface and the optical surface,
the boundary surfaces include first, second, and third intersecting sections,
the reflective/transmissive interface is located on the first section,
the first section separates the second section from the third section, and
the second and third sections are substantially planar.

10. The eyewear of claim 9, wherein the second and third sections are substantially parallel to each other.

11. The eyewear of claim 10, wherein the intersections between the first section and the second and third sections of the boundary surfaces are radiused.

12. The eyewear of claim 11, wherein the first section is planar and the device further includes a magnifying optic disposed along the optical pathway.

13. The eyewear of claim 12, wherein
the inner lens portion is disposed proximate the wearer's eye in use,
the partially transmissive reflector is a coating applied to the first section of the inner lens portion,
the composite lens has first and second opposing edges,
the microdisplay is mounted to the first edge, and
the second and third sections are inclined such that the first edge is thicker than the second edge.
